(19) United States
(12) Patent Application Publication
(10) Pub. No.: US 2014/0312141 A1
(43) Pub. Date: Oct. 23, 2014

(54) Variable Pressure Sprinkler System

(71) Applicant: Gurumurthi Ravishankar, Englewood, CO (US)

(72) Inventor: Gurumurthi Ravishankar, Englewood, CO (US)

(21) Appl. No.: 13/865,056

(22) Filed: Apr. 17, 2013

(51) Int. Cl. B05B 12/12; B05B 1/30

(52) U.S. Cl. CPC B05B 12/12; B05B 1/30
USPC 239/63; 239/569; 239/71; 239/75

(57) ABSTRACT

A sprinkler head has an inlet to receive a fluid from a pipeline, and a nozzle to spray the received fluid. In one embodiment, a body that couples the inlet to the nozzle includes an electromechanical fluid flow control device via which to vary an amount of fluid pressure presented to the nozzle. In another embodiment, the nozzle includes an electromechanical aperture via which to vary a flow of the received fluid. An electromechanical wheel coupled to the nozzle rotates the nozzle in a direction.

### TECHNICAL FIELD

Embodiments of the present invention relate to sprinkler systems used, for example, in agricultural or lawn irrigation systems, or fire suppression systems. In particular, embodiments relate to electromechanical sprinkler heads.

### BACKGROUND ART

A prior art sprinkler head in a sprinkler system typically has a fixed fluid (e.g., water) pressure at the inlet of the head. The fixed pressure is primarily determined by the source of the water, in particular, the rate of flow of water from the source, and the size (diameter) of the pipeline connecting the source to the inlet. For example, inlet pressure is based on how much water is delivered to the sprinkler head over a given period of time, e.g., gallons per minute, from a source such as a water pump, and the size of the pipeline that delivers the water from the source to the sprinkler head. The inlet pressure may be regulated by a value that is opened, for example, by a handle, to a particular setting that does not change during the course of the sprinkler system's operation.

Prior art sprinkler heads do not contain components that allow for the control of either the rotation of the sprinkler head, or the regulation of water pressure at the sprinkler head, which affects the spray pattern of, as well as the distance of, fluid sprayed by the sprinkler head's nozzle. Typically, the rotation or direction of the sprinkler head is controlled by water pressure that applies a force on mechanical components of the sprinkler head, and the distance or pattern of spray is governed by the size of the aperture, or number of apertures, in the nozzle of the sprinkler head. Prior art sprinkler heads also lack means by which to accurately sense when to turn on, or off, the sprinkler, and the direction and duration of spray from the sprinkler head to provide an adequate, uniform, or appropriate, amount of water, as the case may be, resulting in excessive water use.

For example, in an agricultural or lawn irrigation sprinkler system, sprinkler heads are fixed to deliver water in one of 360, 180, 90, 45, or 22.5 degrees in a circular spray pattern. Thus, to irrigate a rectangular area requires multiple sprinkler heads with overlapping spray patterns. Irrigating irregular areas typically results in some portions of the irregular area being over-watered, while other portions are under-watered, resulting in inconsistent or uneven irrigation and a waste of water.

In fire suppression sprinkler systems, sprinkler heads are placed to have maximum coverage of the entire area under protection without regard to water damage that might occur to portions of the area or contents in the area under protection, even if the portions of the area or objects are not near the source of heat or fire. What is needed is a way to direct water from the sprinkler heads only to those portions of the area proximate the source of fire and heat.

### BRIEF DESCRIPTION OF THE DRAWINGS

Embodiments of the invention will be understood more fully from the detailed description given below and from the accompanying drawings of various embodiments of the invention, which, however, should not be taken to limit the invention to the specific embodiments, but are for explanation and understanding only.

FIG. 1 illustrates an aspect of an embodiment of the invention.

FIG. 2 illustrates an embodiment of the invention.

FIG. 3A illustrates an embodiment of the invention.

FIG. 3B illustrates an embodiment of the invention.

FIG. 4 illustrates an embodiment of the invention.

### DESCRIPTION OF THE EMBODIMENTS

Embodiments of the invention employ water pressure regulation, and angular position sensing and control, of a sprinkler head. In one embodiment, the distance that a sprinkler head sprays a fluid, for example, water, is controlled by electromechanical operation of the inlet of the sprinkler head or the nozzle of the sprinkler head. By changing the size of the opening at the inlet of the sprinkler and/or changing the size of the opening, or aperture, of the nozzle of the sprinkler head, the water pressure, and the rate of fluid flow (i.e., the volumetric flow rate) can be regulated at the sprinkler head, which affects the distance the sprinkler head sprays water from the nozzle. In one embodiment, the number of apertures in the nozzle of the sprinkler head may be varied to essentially change the size of overall opening or aperture of the nozzle in the sprinkler head.

In one embodiment of the invention, the location and angular position of the sprinkler head in an area is determined and monitored, and the boundary of the area to be sprayed is mapped. It is therefore possible, given the ability to regulate water pressure at, and control angular position of, the sprinkler head, to spray fluid in any direction within 360 degrees of the sprinkler head location, for an appropriate distance from the location of the sprinkler head that conforms to the shape of the mapped area. (Understandably, the maximum water pressure at the sprinkler head ultimately limits the distance the sprinkle head sprays water.)

In one embodiment of the invention, since the location and angular position of the sprinkler head is known, and since the water pressure at the sprinkler head, and the is direction of spray from the sprinkler head, can be controlled, the time that the sprinkler head sprays water in a particular direction can be controlled, and the distance that the sprinkler head sprays water in that particular direction can be controlled, to provide an appropriate or desired amount of water over the area reached, or covered by, the sprinkler head, or over a portion of the area covered by the sprinkler head, depending on the application. For example, in a lawn-, landscape-, or agricultural-irrigation system, a substantially equal amount of water may be desired across the entire area covered by the sprinkler head. In another example, as in a fire suppression irrigation system, more water may need to be directed to one portion of the area covered by the sprinkler head than another area.

In one embodiment of the invention, water pressure and volume at the sprinkler head is regulated by controlling the size of the inlet to the sprinkler head. In such an embodiment, the nozzle size may be fixed. In another embodiment, the water pressure and volume is regulated by controlling the size, or aperture, of the nozzle of the sprinkler head, or the number of apertures that are open in the sprinkler head. In the case of multiple apertures, by controlling which and how many apertures are open, effectively the size of the aperture can be controlled. In one embodiment, two or more aperture(s) are the same size; in another embodiment, some number of the apertures may differ in size. References herein to the size of the aperture are understood to refer to both the embodiment having a single aperture, the size of which can be controlled, and the embodiment having multiple apertures, in which the number that are open can be controlled. In either embodiment, the inlet size may be fixed.

In another embodiment, both the inlet and the nozzle size may be independently controlled, or controlled in combination, to provide any level of water pressure, and water flow, at the sprinkler head. These embodiments of the invention provide for a desired volume of spray that reaches a desired distance. The volume and distance of spray that can be achieved is limited only by the water pressure available to the sprinkler head from the pipeline that couples the sprinkler head to the water supply.

In one embodiment of the invention, a controller is coupled with a sprinkler head, either as a component of the sprinkler head, or as a remote controller accessible to the sprinkler head via a wired or wireless communications channel and a communications interface on the sprinkler head.

In the remote controller embodiment, the remote controller is a computing device, such a personal computer or microcontroller, at a fixed, remote location (relative to the location of the sprinkler head). The remote controller comprises application software and a wired or wireless communications interface coupled to the communications channel so that the controller can communicate with the sprinkler head.

In another remote controller embodiment, the remote controller is a wireless mobile device, such as a tablet computer or smart phone, with associated application software and a wireless communications interface coupled to the communications channel so that the controller can communicate with the sprinkler head.

In yet another remote controller embodiment, the remote controller may be a computing device, such as a personal computer or microcontroller, at a fixed, or mobile, remote location, with associated application software and a wired or wireless communications interface via which to communicate with a separate, wireless mobile computing device such as a tablet computer or smart phone. In this embodiment, the wireless mobile computing device also has associated application software and a wireless communications interface coupled to the communications channel so that the wireless mobile computing device can communicate with the sprinkler head and the remote controller, or so that the remote controller can communicate directly with the sprinkler head via the wireless mobile computing device. In the latter case, the wireless mobile computing device may serve only to communicate information between the remote controller and the sprinkler head and thus may need no application specific software.

In the description hereafter, references to “the controller” contemplate all the controller embodiments described above without going into the details of whether the controller is integrated with the sprinkler head, remote from the sprinkler head, integrated into a wireless mobile computing device, or separate therefrom, unless specifically stated otherwise in one embodiment.

The controller can compute the volumetric flow rate of water being delivered by the sprinkler head for any given combination of aperture size at the nozzle and water pressure at the inlet. In one embodiment of the invention, the rate of fluid flow through the sprinkler head can be used to regulate the rate and degree of rotation in is the angular position of the sprinkler head to provide a desired amount of water over some portion or all of the area that a spray of water from the sprinkler head can reach. In one embodiment, the desired amount of water may be the same amount of water in every direction to provide even watering or irrigation. In other embodiments, depending, for example, on varying conditions in soil type, flora, amount of sunlight or shade, terrain or landforms, or shape of the area covered by the sprinkler head, the desired amount of water may involve differing amounts of water being provided in differing sections of the total area reachable by the sprinkler head's spray.

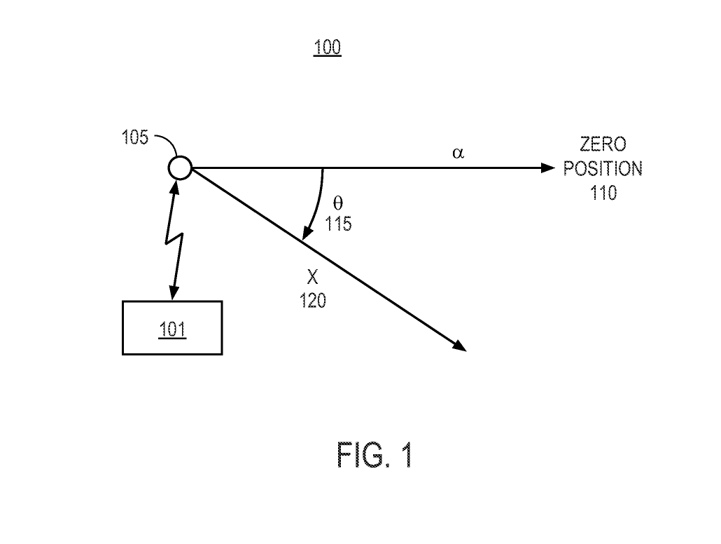

With reference to FIG. 1, in one embodiment of the invention 100, a zero degree, or reference, angular position 110, (α), may be established for a sprinkler head 105, The reference angular position is simply an arbitrary starting position for the direction of spray from the sprinkler head. All other angular positions of the sprinkler head, may be represented by an angular distance 115, (θ), from the reference position, α, having a value ranging from 0 to 360 degrees. Furthermore, the location of the sprinkler head within the area to be watered by the sprinkler head can be determined, whether by way of user input to the controller, or automated means such as a GPS transceiver coupled to the sprinkler head, or triangulation techniques used in cellular communications to pinpoint the location of a cellular mobile communications device transceiver coupled to the sprinkler head.

Given a known location of the sprinkler head, every location along the perimeter of the area to be covered by water from the sprinkler head is a distance 120 (x) from the sprinkler head location, and every position along the perimeter of the area can be mapped as (x, θ). In one embodiment, sprinkler head 105 communicates with a processor or controller, e.g., controller 101. The sprinkler head communicates its angular position, θ, relative to the reference angular position, to the controller. The controller saves this information in an associated memory and in so doing has the ability to monitor the angular position at any point in time. For every angular position the sprinkler head communicates to the controller and that the controller saves in associated memory, data values such as aperture or nozzle size, inlet water pressure, and other information related to the water pressure that enables the water stream to reach the perimeter of the area to be watered at that angular position may also be communicated to, and saved in associated memory by, the controller. This additional information is linked with or otherwise related to the saved angular position. In so doing, the controller has the ability to monitor and control the water pressure for each angular position of the sprinkler head, once it is in operation.

In one embodiment, mapping the area to be covered by a sprinkler head may be accomplished as follows. First, a user stands proximate the sprinkler head, with the controller, wireless mobile computing device, or wireless mobile communications device, in hand, and either receives input directly from the sprinkler head or provides user input, uniquely identifying the sprinkler head, and setting the zero value angular position 110, (α). This value is saved in the controller, Next, with the line pressurized with fluid, and a fluid flow control device such as an inlet pressure control valve, and/or the aperture, is closed, so no water is presently spraying from the nozzle. The user then opens the fluid flow control device and/or nozzle. For example, if only an inlet pressure control valve is closed, it may be opened, for example, by turning a handle coupled to the valve, adjusting the valve until a stream from the sprinkler head reaches the perimeter of the area to be covered at that current angular position (position 110, (α)). The parameters that identify, and that are later to be retrieved and used to control the valve setting, are saved in the memory accessible to the controller, in association with the current angular position. In one embodiment, such parameters may merely reflect the position of the control valve or the handle used to adjust the control valve. In one embodiment, the parameters may include inlet and/or nozzle pressures if sensors are used to detect such (as described further below).

The angular position of the sprinkler head is then incremented to a new angular position, e.g., an angular distance 115, (θ), from the reference position, α. In one embodiment, the new angular position is achieved by sending signals to the controller that in turn drives the angular positioning device. These signals may be provided by user input, in one embodiment, or by manually rotating the sprinkler head, in another embodiment. For the entire range starting with position 110 (α) to the new angular position at an angular distance 115 θ from position 110 (α), the fluid control device and/or nozzle aperture remains unchanged. This new angular position is saved in the controller's associated memory.

The angular position is again incremented as described above, as needed to further is map the area to be covered by the sprinkler head. If at any new angular position the perimeter of the area to be covered changes, the new distance, x, at that angular position, is achieved by sending signals to the controller that control the amount of fluid pressure presented to the nozzle of the sprinkler head or exiting the fluid flow control device. These signals may be provided by user input to controller, in one embodiment, or by manually operating the sprinkler's valve handle and/or nozzle, in another embodiment. The above sequence is repeated until the needed or desired reference positions and concomitant distances to cover the entire area being mapped are saved to the controller's memory. One embodiment of the invention uses components to regulate water pressure at the sprinkler head and control the rotation of the sprinkler head to control the direction of spray provided by the sprinkler head. Such components may comprise one or more of mechanical, electromechanical, and hydraulic components. Control and data signals are exchanged between the sprinkler head and the controller to provide input to control and to receive information to monitor the various components of the sprinkler head. The sprinkler head may comprise a conventional wired or wireless communication interface to transfer control and data signals with the controller. For example, the sprinkler head may use cellular, Wi-Fi, Bluetooth, or other such wireless communication standards and technology to transmit and receive information with a controller regarding the control and monitoring of the sprinkler head.

In one embodiment, the controller may coordinate control and monitoring of a plurality of sprinkler heads in a given area, or across a plurality of contiguous or dis-contiguous areas provided water in accordance with a single irrigation or fire suppression system.

Conversely, the controller may coordinate control and monitoring of a plurality of sprinkler heads to cover any area of geometry including spaces, enclosed or otherwise, that should not be watered, or are desired not to be watered.

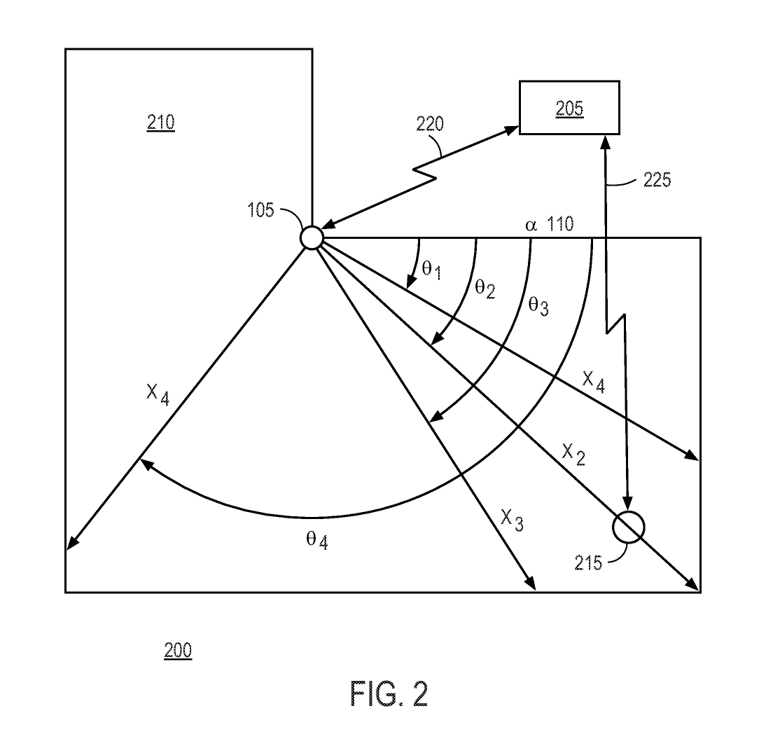

With reference to FIG. 2, a sprinkler head 105 in a sprinkler system 200 “covers” an area 210, that is, the single sprinkler head is capable of watering only the space within that area 210 and not any space outside that area 210. The sprinkler head communicates with controller 205 over communications channel 220, e.g., a wireless communications channel. The controller receives a signal from sprinkler head 105 that identifies the location of sprinkler head 105 as well as the initial or reference is angular position 110. In one embodiment, the sprinkler head is located on an edge or along the perimeter of the area to be covered. It is understood, however, that the sprinkler head may be located anywhere in the area to be covered depending on the watering application and other factors such as installation costs, operation costs, water supply, aesthetics, the presence of one or more other sprinkler heads in the area, etc.

The controller, in one embodiment, further includes a map of the area 210 to be covered by the sprinkler head 105 whose boundaries are defined by a finite combination of angular position, θ, and distance, x, from the sprinkler head. The controller transmits control signals to sprinkler head 105. In one embodiment of the invention, the controller sends a control signal to the sprinkler head to control or regulate the water pressure, either at the inlet of the sprinkler head or at the outlet, or nozzle, of the sprinkler head, based on the distance, x, that the sprinkler head needs to spray in a particular direction to reach the perimeter of the area. For example, the controller transmits a control signal to the sprinkler head to control or regulate the water pressure of the sprinkler head, based on the distance x1 that the sprinkler head needs to spray in the direction defined by angular position θ1. Distance x2, which reaches a corner of the area covered by water sprayed by the sprinkler head, is greater than distance x1. Thus, the controller transmits another control signal to the sprinkler head to increase the water pressure of the sprinkler head based on the longer distance x2 that the sprinkler head needs to spray in the direction defined by angular position θ2. In like manner, the controller transmits control signals to the sprinkler head to increase or decrease the water pressure of the sprinkler head based on the distances x3 and x4 that the sprinkler head needs to spray in the respective directions defined by angular positions θ3 and θ4.

In one embodiment, the angular position of the sprinkler head is set according to the operation of an electromechanical device such as a stepper motor, wheel or disc. The controller, given the reference angle 110 (α), and a map of the area 210 to be watered, can send a control signal to the device to rotate the sprinkler head an angular distance, such as θ2, relative to the reference angle 110 (α) so that the sprinkler outlet or nozzle points in an appropriate direction. The rate at which control signals are transmitted from the controller to the sprinkler head to rotate the sprinkler head from one angular position to another angular position governs the rate of angular change of the sprinkler head, which determines the duration for which the sprinkler head waters the area it is pointing in covered by the sprinkler head.

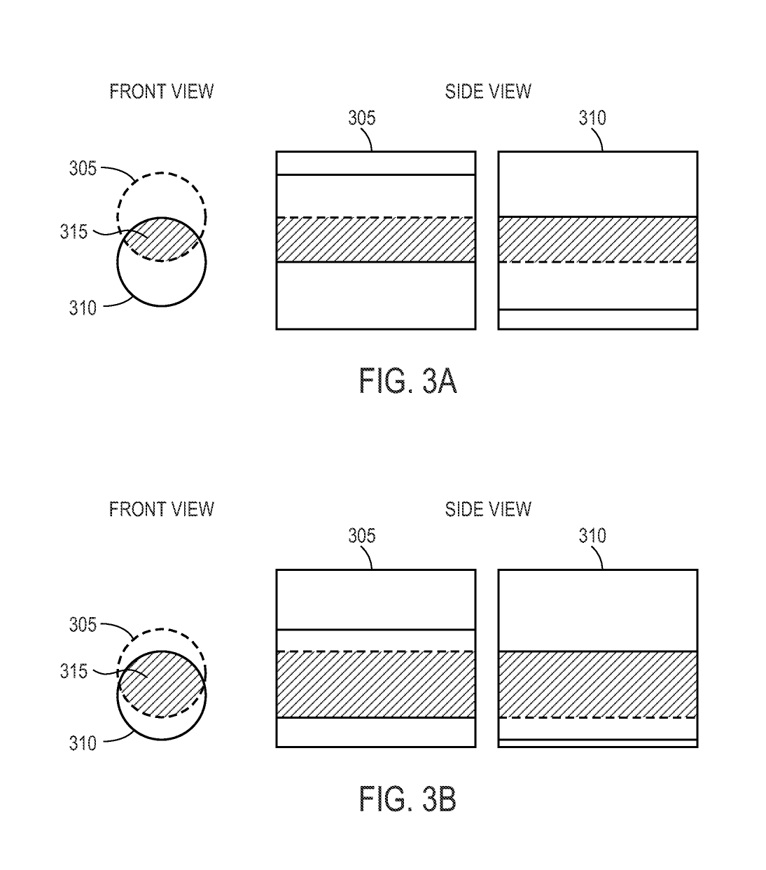

In one embodiment of the invention, the water pressure at the sprinkler head can be controlled at the outlet, or nozzle of the sprinkler head. FIGS. 3A and 3B illustrate one embodiment of such a nozzle. The sprinkler nozzle comprises a fixed cylinder 305 and a moveable cylinder 310, each with eccentric holes. In FIG. 3A the holes overlap to the extent depicted at 315, providing an opening or aperture 315 with a first level of water pressure and volumetric flow rate. In FIG. 3B, the holes overlap to a greater extent as depicted at 315, providing a bigger opening or aperture 315 with a second level of water pressure and volumetric flow rate. If the inlet water pressure is the same in each case, then the water pressure at the nozzle is greater in the opening in FIG. 3A versus the opening in FIG. 3B. In one embodiment, rotating cylinder 310 causes the aperture 315 size to change. In one embodiment the cylinder 310 is electromechanically controlled to rotate and thereby change the aperture 315 size of the nozzle. The sprinkler head communicates the position of the moveable cylinder to a controller. The controller stores the information in a local, or associated, memory store. The controller can read the information from memory at any time to determine the current aperture size and send a control signal to the sprinkler head to move the cylinder to increase or decrease the aperture size as needed to increase or decrease the nozzle water pressure and thereby increase or decrease, as the case may be, the distance the nozzle shoots or sprays water.

In one embodiment, the position of the moveable cylinder determines how far the spray reaches for a fixed inlet water pressure at the sprinkler head. The angular position of the sprinkler head informs the irrigation system the direction in which the sprinkler head is pointed. The controller calculates, in one embodiment, the volumetric flow rate based on the size of the aperture 315 created by the moveable cylinder and stores this data in an associated memory. The cylinder position and the angular position, and the flow rate, are used subsequently to ensure appropriate, for example, even, watering. The aperture (315) may be of any shape including annular, and the device used to regulate the size of the aperture may be one of many commonly used device and/or methods for aperture control.

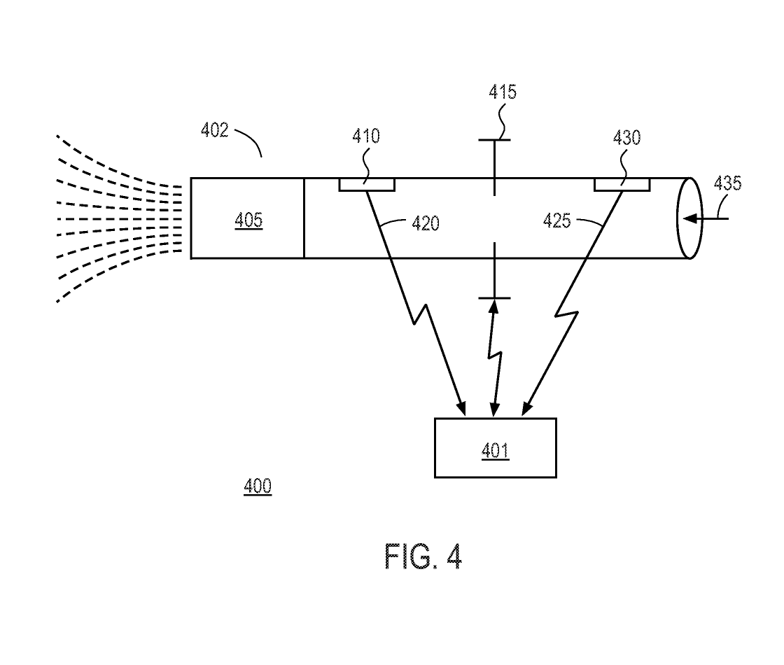

is In one embodiment of the invention 400, the water pressure at the sprinkler head can be controlled at the inlet of the sprinkler head. The embodiment is illustrated in FIG. 4. The sprinkler head 402 comprises a nozzle 405 and an inlet 435 via which water enters the sprinkler head from a pipeline coupled to a water supply. The body of the sprinkler head is divided into a front portion 420 and a back portion 425. A fluid flow control device, such as valve 415 is situated between and defined portions 420 and 425. The valve is operated so that it can decrease or increase the fluid flow through the body and presented to the nozzle 405. If the pipeline water pressure is fixed, the controllable valve is operated to achieve a desired output pressure to the nozzle. Nozzle pressure and inlet pressure sensors 410 and 430 respectively detect water pressure at the output to the nozzle (water pressure P1), and at the inlet (water pressure value P2). The values of P1 and P2 are communicated from the sensors to a controller 401, as is the valve setting. The controller stores these values along with the angular position of the sprinkler head used during operation. The duration of time that the sprinkler head remains at any given angular position can be controlled, and varied, to achieve an appropriate volumetric flow of water at any particular portion of the area covered by the sprinkler head. The controller can calculate this period of time based on the nozzle size and P1. In one embodiment the valve 415 is such that for the specific values of inlet pressure (P2) the nozzle pressure (P1) is adjustable solely by controlling the valve settings.

In one embodiment of the invention an environment-based sensor, such as a moisture sensor, or a heat sensor, can be installed to further control the operation of the watering system. For example, in FIG. 2, a heat sensor, for example, a directional infrared sensor, 215, can be placed in the area covered by the sprinkler head to detect and transmit sensor data via a communications channel to the controller. The controller can in response to receiving such sensor data, send a control signal to the sprinkler head to change its angular position and/or its water pressure as described in the above embodiments, so as to direct an appropriate amount of water in an appropriate direction for an appropriate period of time. For example, in the event of a fire or a significant change (e.g., increase) in heat or temperature detected by the sensor 215, the sprinkler head can be directed to send water in the direction in which the change in heat is detected. Once the sensor detects the heat falls below a certain is threshold, the sensor can again communicate with the controller such information, and the controller, in turn, can send appropriate signals to the sprinkler head, for example, turning off the sprinkler head by closing the valve.

In one embodiment, the position of the sensor relative to the sprinkler head provides the reference angular position, or zero position, of the sprinkler head. In such an embodiment, when the heat sensor detects a significant increase in heat, for example, the heat increases beyond a threshold indicating a fire or threat of fire at a particular location within the area covered by the sprinkler head, the head can be turned directly toward the source of heat and turned on.

In one embodiment, a plurality of sprinkler heads and/or a plurality of sensors may be installed in the area to be covered, such as a lawn in which an irrigation system is installed, or a multi-room building in which a fire suppression sprinkler system is installed. As in the embodiments described above in which a single sprinkler head is installed, in the multiple sprinkler head configuration, each sprinkler head's location and angular position is determined, as is each sensor. A single, central, controller can communicate with each sprinkler head and each sensor. In the fire suppression irrigation system example, in the event of multiple fires, each of the sensors that detect the change in heat communicate with controller, which in turn directs the appropriate heads to spray water in the direction of the fires. In one embodiment, a plurality of controllers may be used, with a given controller communicating with a subset of sprinkler heads and all controllers working in conjunction with each other. In an agricultural irrigation system example, moisture sensors are used to detect the need for watering at separate locations. The position of any sensor can be used to establish the angular position of any sprinkler head. Thereafter, a particular sprinkler head can be directed towards a particular moisture sensor based on the location sprinkler head relative to the sensor and by sending a control signal from the controller to the sprinkler head to change the angular position of the sprinkler head in the general in direction of the sensor.

An embodiment of the invention involves a sprinkler head, comprising an inlet to receive a fluid from a pipeline, a nozzle to spray the received fluid, and a body coupling the inlet to the nozzle, the body comprising a fluid flow control device via which to vary an amount of fluid pressure presented to the nozzle. The sprinkler head is further comprises a communications interface coupled to the fluid flow control device via which to receive a control signal to control the fluid flow control device. In one embodiment, the sprinkler head body further comprises a sensor, located between the fluid flow control device and the nozzle, coupled to the communications interface, to detect the amount of fluid pressure presented to the nozzle. The communications interface receives from the sensor, and transmits to a controller a value that indicates the amount of fluid pressure at the nozzle. In one embodiment, the controller is located remotely from the sprinkler head, and the communications interface is a wireless communications interface.

In the embodiment, the sprinkler head body further comprises another sensor, located between the fluid flow control device and the inlet, coupled to the communications interface, to detect an amount of fluid pressure presented at the inlet. The communications interface receives from this sensor, and transmits to the controller, a value. P2, that indicates the amount of fluid pressure at the inlet.

The sprinkler head, in one embodiment, further includes an electromechanical device coupled to the nozzle via which to rotate the nozzle in a direction. A communications interface coupled to the device receives from the device, and transmits to a controller, a data signal comprising a value, α, indicating a reference angular position of the sprinkler head nozzle. The communications interface further receives a control signal to control the rotation of the sprinkler head nozzle an angular distance, θ, relative to α. In one embodiment, the control signal is periodically received at the communications interface.

In one embodiment, an environmental sensor is coupled to the communications interface. The communications interface receives from the environmental sensor, and transmits to the controller an indication of an environmental condition proximate the sprinkler head. The environmental sensor could be a moisture sensor, a directional infrared sensor, and a directional heat sensor, etc. The control signal that the communications interface receives to control the rotation of the sprinkler head nozzle the angular distance, θ, relative to α, is further responsive to the input received from the environmental sensor.

In another embodiment, a sprinkler head includes an inlet to receive fluid from a pipeline, a body coupled to the inlet to receive fluid from the inlet, and a nozzle is coupled to the body to spray the received fluid. The nozzle includes an adjustable aperture via which to vary a flow of the received fluid. A communications interface is coupled to the nozzle via which to receive a control signal to control a size of the aperture in the nozzle to vary the flow of the received fluid. The nozzle further comprises a sensor to detect the size of the aperture. The communications interface receives from the sensor, and transmits to a controller, a value, S, that indicates the size of the aperture. In one embodiment, the controller is located remotely from the sprinkler head, and the communications interface is a wireless communications interface. In one embodiment, the sprinkler head further comprises an electromechanical device coupled to the nozzle via which to rotate the nozzle in a direction. In such an embodiment, the sprinkler head includes a communications interface coupled to the device to receive from the device, and transmit to a controller, a data signal comprising a value, α, indicating a reference angular position of the sprinkler head nozzle. The communications interface further receives a control signal to control the rotation of the sprinkler head nozzle an angular distance, θ, relative to α. The control signal may be periodically received at the communications interface in one embodiment.

In the above description, numerous specific details are set forth. However, it is understood that embodiments of the invention may be practiced without these specific details. In other instances, well-known components and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not is explicitly described.

Embodiments of the invention as discussed above may be implemented at least in part as a series of software routines executed by computer system. The software routines may comprise a plurality or series of instructions, code sequences, configuration information, or other data to be accessed and/or executed by a processing system such as one or more processors. Initially, the series of instructions, code sequences, configuration information, or other data may be stored in data storage and transferred to memory via a bus. It is to be appreciated that the series of instructions, code sequences, configuration information, or other data can be stored in a data storage using any conventional computer-readable or machine-accessible storage medium, such as a memory chip, CD-ROM, magnetic tape, DVD, ROM, etc. The instructions, code sequences, configuration information, or other data may be copied from the data storage, such as mass storage, and accessed and executed by a processor.

In alternate embodiments, the present invention is implemented in discrete hardware or firmware. For example, one or more application specific integrated circuits (ASICs) could be programmed with some or all of the above-described electromechanical functions of the present invention.

Accordingly, embodiments of an invention that improve sprinkler systems are described. From the foregoing description, those skilled in the art will recognize that many other variations of embodiments of the invention are possible. Thus, embodiments of the invention are not limited by the details described. Instead, embodiments of the invention can be practiced with modifications and alterations within the spirit and scope of the appended claims.

1. A sprinkler head, comprising:
an inlet to receive a fluid from a pipeline;
a nozzle to spray the received fluid;
a body coupling the inlet to the nozzle, the body comprising a fluid flow control device via which to vary an amount of fluid pressure presented to the nozzle; and
a position control device via which an angular direction of the nozzle may be controlled.

2. The sprinkler head of claim 1, further comprising a communications interface coupled to the fluid flow control device and the position control device via which to send and receive control signals to control the fluid flow control device and the position control device.

3. The sprinkler head of claim 2, wherein the communications interface coupled to the fluid flow control device and the position control device via which to send and is receive control signals to control the fluid flow control device and the position control device is coupled to a controller located remotely from the sprinkler head, and wherein the communications interface is a wireless communications interface.

4. The sprinkler head of claim 2, wherein the communications interface is coupled to the position control device to receive from the device, and transmit to a controller, a data signal comprising a value, α, indicating a reference angular position of the sprinkler head nozzle.

5. The sprinkler head of claim 2, wherein the communications interface coupled to the position control device via which to receive control signals to control the position control device receives a control signal to control a rotation of the sprinkler head nozzle an angular distance, θ, relative to α.

6. The sprinkler head of claim 2, wherein the control signals are periodically received at the communications interface.

7. The sprinkler head of claim 2, wherein the fluid flow control device transmits to the communications interface a value of a setting for the fluid flow control device, the value indicating an amount of fluid pressure presented at the inlet.

8. The sprinkler head of claim 2, wherein the body further comprises an inlet sensor, located between the fluid flow control device and the inlet, coupled to the communications interface, to detect an amount of fluid pressure presented at the inlet, the communications interface to receive from the inlet sensor, and transmit to the controller, a value that indicates the amount of fluid pressure at the inlet.

9. The sprinkler head of claim 2, wherein the body further comprises a nozzle sensor, located between the fluid flow control device and the nozzle, coupled to the communications interface, to detect the amount of fluid pressure presented to the nozzle, the communications interface to receive from the nozzle sensor, and transmit to a controller, a value that indicates the amount of fluid pressure presented at the nozzle.

10. The sprinkler head of claim 9, further comprising an environmental sensor coupled to the communications interface, the communications interface to receive from the environmental sensor, and transmit to the controller, a value, E, that indicates an environmental condition proximate the sprinkler head.

11. The sprinkler head of claim 9, wherein the environmental sensor is selected from a group consisting of: a moisture sensor, a directional infrared sensor, and a directional heat sensor, and wherein the environmental condition is respectively selected from a group consisting of: moisture content of soil, infrared light, and temperature.

12. The sprinkler head of claim 10, wherein the control signal that the communications interface is to receive to control the rotation of the wheel the angular distance, θ, relative to α, is further responsive to the value, E.

13. A sprinkler head, comprising:
an inlet to receive fluid from a pipeline;
a body coupled to the inlet to receive fluid from the inlet;
a nozzle coupled to the body to spray the received fluid, the nozzle comprising an adjustable aperture via which to vary a flow of the received fluid.

14. The sprinkler head of claim 13, further comprising a communications interface coupled to nozzle via which to receive a control signal to control a size of the aperture to vary the flow of the received fluid.

15. The sprinkler head of claim 14, wherein the nozzle further comprises a sensor to detect the size of the aperture, the communications interface to receive from the sensor, and transmit to a controller, a value, S, that indicates the size of the aperture.

16. The sprinkler head of claim 15, wherein the controller is located remotely from the sprinkler head, and the communications interface is a wireless communications interface.

17. The sprinkler head of claim 13, further comprising an electromechanical wheel coupled to the nozzle via which to rotate the nozzle in a direction.

18. The sprinkler head of claim 15, further comprising a communications interface coupled to the wheel to receive from the wheel, and transmit to a controller, a data signal comprising a value, α, indicating a reference angular position of the wheel.

19. The sprinkler head of claim 18, wherein the communications interface further to receive a control signal to control the rotation of the wheel an angular distance, θ, relative to a.

20. The sprinkler head of claim 19, wherein the control signal is aperiodically received at the communications interface.

21. The sprinkler head of claim 19, further comprising an environmental sensor coupled to the communications interface, the communications interface to receive from the environmental sensor, and transmit to the controller, a value, E, that indicates an environmental condition proximate the sprinkler head.

22. The sprinkler head of claim 19, wherein the environmental condition is selected from a group consisting of: moisture content of soil, directional infrared sensor, and directional heat sensor.

23. The sprinkler head of claim 21, wherein the environmental sensor is selected from a group consisting of: a moisture sensor, a directional infrared sensor, and a directional heat sensor, and wherein the environmental condition is respectively selected from a group consisting of: moisture content of soil, infrared light, and temperature.
